(19) United States
(12) Patent Application Publication
(10) Pub. No.: US 2008/0155441 A1
(43) Pub. Date: Jun. 26, 2008

(54) METHOD FOR PERFORMING A DATA CENTER HARDWARE UPGRADE READINESS ASSESSMENT

(76) Inventors: Bruce T. Long, Pelham, NH (US); Gary P. Wong, Londonderry, NH (US)

Correspondence Address: LOWRIE, LANDO & ANASTASI, LLP, ONE MAIN STREET, SUITE 1100, CAMBRIDGE, MA, 02142, US

(21) Appl. No.: 11/862,918

(22) Filed: Sep. 27, 2007

Related U.S. Application Data
(60) Provisional application No. 60/876,846, filed on Dec. 22, 2006.

(51) Int. Cl. G06F 17/30; G06F 3/14

(52) U.S. Cl. 715/771; 707/104.1; 707/E17.005

(57) ABSTRACT

A system and method are provided for assessing the readiness of a data center to support a hardware upgrade. In one embodiment, this method may employ a computer based system to administer a questionnaire to data center personnel, assess the data center and report the results. Using the data gathered by the questionnaire and during the data center assessment, a service provider analyzes the data center and reports the results of this analysis in a series of textual, tabular and graphical reports.

### RELATED APPLICATIONS

This application claims priority under 35 U.S.C. 119(e) to U.S. Provisional Application 60/876,846 filed Dec. 22, 2006 and entitled “Method for Performing a Data Center Hardware Upgrade Readiness Assessment,” which is hereby incorporated by reference in its entirety.

### BACKGROUND OF INVENTION

1. Field of Invention

At least one embodiment of the invention relates generally to a method and system for evaluating the capacity of a data center to support various information technology equipment, and more specifically, to a method and system for performing a data center hardware upgrade readiness assessment.

2. Discussion of Related Art

In response to the increasing demands of information-based economies, information technology networks continue to proliferate across the globe. One manifestation of this growth is the centralized network data center. A centralized network data center typically consists of various information technology equipment, collocated in a structure that provides telecommunication connectivity, electrical power and cooling capacity. Often the equipment is housed in specialized enclosures termed “racks” which integrate these connectivity, power and cooling elements. These characteristics make data centers a cost effective way to deliver the computing power required by modern applications.

The sizable installed base of centralized network data centers has created a significant market for software, hardware and services directed toward data center monitoring, support and maintenance. Attempts to meet this market demand include network monitoring and management software, specialized computing hardware and enclosures, and data center design and construction services.

Unfortunately, these technological advances tend to trickle into data centers over time and in an uncoordinated manner. Thus, as data centers age, changes in their constituent components can lead to unforeseen integration issues. One example of such an integration issue is the introduction of blade servers into a data center. Blade servers have the computing power of a full-sized server on a significantly reduced physical footprint. Blade servers may be characterized as having dense resource demands because relative to their physical footprint, they have increased power and cooling requirements over traditional servers. Thus, the introduction of blade servers to a data center may overly burden its power and cooling systems.

### SUMMARY OF INVENTION

There is a need to efficiently assess the readiness of a data center to accept updated equipment and present the data in a format that is useful for different types of users. For instance, a method and system to efficiently determine and articulate the actions necessary for a data center to support a targeted amount of dense resource demand equipment would enable data center personnel to assess the potential costs and benefits of upgrading to such equipment.

According to one aspect of the invention, a method is provided for evaluating a capability of a data center to support dense resource demand hardware. The method includes gathering information related to attributes of the data center, processing the information to determine the capability of the data center to support dense resource demand hardware, displaying a representation of the data center based on the processed information indicating the capability of the data center to support dense resource demand hardware.

In the method, gathering information related to attributes of the data center may include gathering, by presenting a sequence of questions, information related to the attributes of the data center. In the method, processing the information to determine the capability of the data center to support dense resource demand hardware may include processing the information to determine the capability of the data center to support blade server hardware. In the method, displaying the representation of the data center may include displaying a plurality of rack indicators, each rack indicator representing a rack disposed within the data center, and the method may also include identifying at least one of the plurality of rack indicators representing a rack targeted for additional hardware. In the method, displaying the representation of the data center may include displaying at least one power supply load indicator representing power supply load of a power supply of the data center, displaying at least one gross power supply capacity indicator representing gross power supply capacity of a power supply of the data center and displaying at least one net power supply capacity indicator representing net power supply capacity of a power supply of the data center. In the method, displaying the representation of the data center may include displaying at least one power distribution load indicator representing power distribution load of the data center, displaying at least one gross power distribution capacity indicator representing gross power distribution capacity of the data center and displaying at least one net power distribution capacity indicator representing net power distribution capacity of the data center. In the method, displaying the representation of the data center may include displaying at least one cooling load indicator representing the cooling load of the data center, displaying at least one gross cooling capacity indicator representing the gross cooling capacity of the data center and displaying at least one net cooling capacity indicator representing the net cooling capacity of the data center. In the method, displaying the representation of the data center may include displaying at least one rack indicator representing a rack having a rack inlet temperature and disposed within the data center, the at least one rack indicator indicating the rack inlet temperature, displaying at least one hot aisle indicator representing a hot aisle disposed within the data center, displaying at least one cold aisle indicator representing a cold aisle disposed with the data center and displaying at least one air flow indicator representing a flow of air within an indicated volume of the data center. In the method, displaying the representation of the data center may include displaying at least one rack indicator representing a rack having a rack inlet temperature and disposed within the data center, the at least one rack indicator indicating the rack inlet temperature, displaying at least one hot aisle indicator representing a hot aisle having a hot aisle temperature and disposed within the data center, the at least one hot aisle indicator indicating hot aisle temperature and displaying at least one cold aisle indicator representing a cold aisle having a cold aisle temperature and disposed with the data center, the at least one cold aisle indicator indicating cold aisle temperature. In the method, displaying the representation of the data center may include displaying at least one rack indicator representing a rack having a rack occupancy percentage and disposed within the data center, the at least one rack indicator indicating the rack occupancy percentage. In the method, displaying the representation of the data center may include displaying at least one rack space capacity indicator representing the rack space capacity of an indicated volume within the data center and displaying at least one rack space utilization indicator representing the rack space utilization of the indicated volume. In the method, displaying the representation of the data center may include displaying at least one power and cooling indicator representing power and cooling load of the data center, displaying at least one bulk power capacity indicator representing bulk power capacity of the data center, displaying at least one bulk cooling capacity indicator representing bulk cooling capacity of the data center and displaying at least one power distribution capacity indicator representing power distribution capacity of the data center. In the method, displaying the representation of the data center may include displaying at least one projected power and cooling indicator representing a projected power and cooling load for the data center.

According to another aspect of the invention, a computer-readable medium is provided having computer-readable signals stored thereon that define instructions that, as a result of being executed by a processor, instruct the processor to perform a method for displaying a capability of a data center to support dense resource demand hardware. The method includes gathering information related to attributes of the data center, processing the information to determine the capability of the data center to support dense resource demand hardware and displaying a representation of the data center based on the processed information indicating the capability of the data center to support dense resource demand hardware.

In the method defined by the instruction on the computer-readable medium, gathering information related to attributes of the data center may include gathering, by presenting a sequence of questions, information related to the attributes of the data center. In the method defined by the instruction on the computer-readable medium, displaying the representation of the data center may include displaying at least one power and cooling indicator representing the power and cooling load of the data center, displaying at least one bulk power capacity indicator representing the bulk power capacity of the data center, displaying at least one bulk cooling capacity indicator representing the bulk cooling capacity of the data center and displaying at least one power distribution capacity indicator representing the power distribution capacity of the data center. In the method defined by the instruction on the computer-readable medium, displaying the representation of the data center may include displaying at least one projected power and cooling indicator representing a projected power and cooling load for the data center.

According to another aspect of the invention, a system is provided for displaying a capability of a data center to support dense resource demand hardware. The system includes an input configured to gather information related to attributes of the data center, an output configured to display a representation indicating the capability of the data center to support dense resource demand hardware, a processor, coupled to the input and the output, and configured to determine the capability of the data center to support dense resource demand hardware and to instruct the output to display the representation and a storage device coupled to the processor.

In the system, the input may be configured to gather the information by displaying a sequence of questions. In the system, the input may be configured to gather the identity of at least one rack targeted for additional hardware and the representation may include at least one rack indicator representing the at least one rack. In the system, the representation may include at least one power and cooling indicator representing power and cooling load of the data center, at least one bulk power capacity indicator representing bulk power capacity of the data center, at least one bulk cooling capacity indicator representing bulk cooling capacity of the data center and at least one power distribution capacity indicator representing power distribution capacity of the data center. In the system, the representation may include at least one projected power and cooling indicator representing a projected power and cooling load for the data center. In the system, the representation may include at least one power supply load indicator representing power supply load of a power supply of the data center, at least one gross power supply capacity indicator representing gross power supply capacity of a power supply of the data center and at least one net power supply capacity indicator representing net power supply capacity of a power supply of the data center. In the system, the representation may include at least one power distribution load indicator representing power distribution load of the data center, at least one gross power distribution capacity indicator representing gross power distribution capacity of the data center and at least one net power distribution capacity indicator representing net power distribution capacity of the data center.

### BRIEF DESCRIPTION OF DRAWINGS

The accompanying drawings, are not intended to be drawn to scale. In the drawings, each identical or nearly identical component that is illustrated in various figures is represented by a like numeral. For purposes of clarity, not every component may be labeled in every drawing. In the drawings:

FIG. 1 is a flow chart of a process for performing a data center hardware upgrade readiness assessment according to one embodiment of the invention;

FIG. 2 is a flow chart of a process for evaluating a data center according to one embodiment of the invention;

FIG. 3 depicts a one line block diagram according to one embodiment of the invention;

FIG. 4 shows a potential upgrade floor plan diagram in accordance with one embodiment of the invention;

FIG. 5 depicts a projected data center load against available power and cooling diagram in accordance with one embodiment of the invention;

FIG. 6 illustrates a gross power capacity against utilized power capacity diagram in accord with one embodiment of the invention;

FIG. 7 shows a gross power distribution capacity against utilized power distribution capacity diagram in accord with one embodiment of the invention;

FIG. 8 illustrates a gross cooling capacity against utilized cooling capacity diagram in accord with one embodiment of the invention;

FIG. 9 shows a rack inlet temperature against cooling distribution floor plan diagram in accordance with one embodiment of the invention;

FIG. 10 depicts a rack utilization floor plan diagram in accordance with one embodiment of the invention;

FIG. 11 illustrates a U space utilization diagram in accordance with one embodiment of the invention;

FIG. 12 shows a general-purpose computer system upon which various embodiments of the invention may be practiced;

FIG. 13 illustrates a storage device of a general-purpose computer system; and

FIG. 14 depicts a network of general-purpose computer systems.

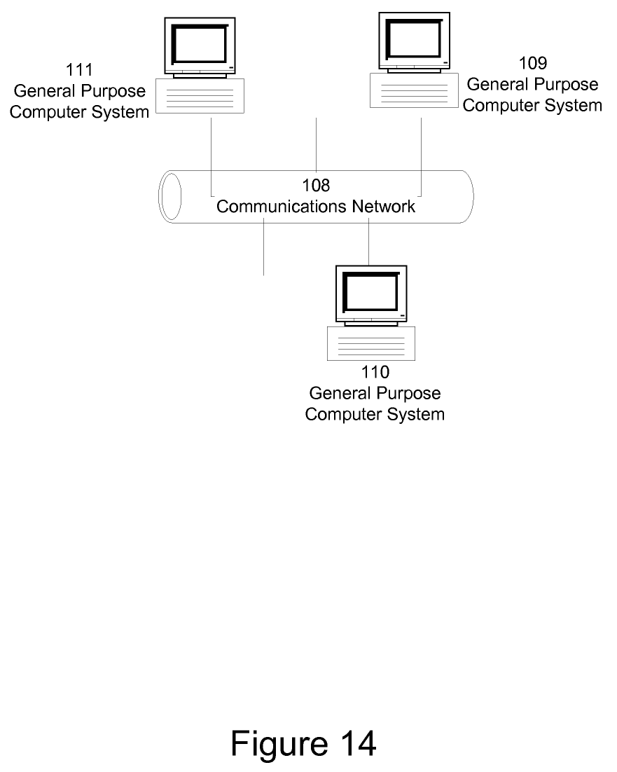

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including”, “comprising”, “having”, “containing”, “involving” and variations thereof herein, is meant to be open-ended, i.e. including but not limited to.

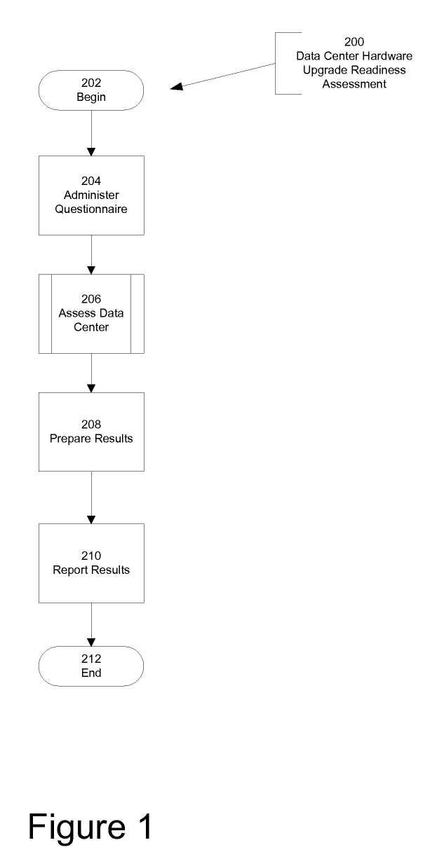

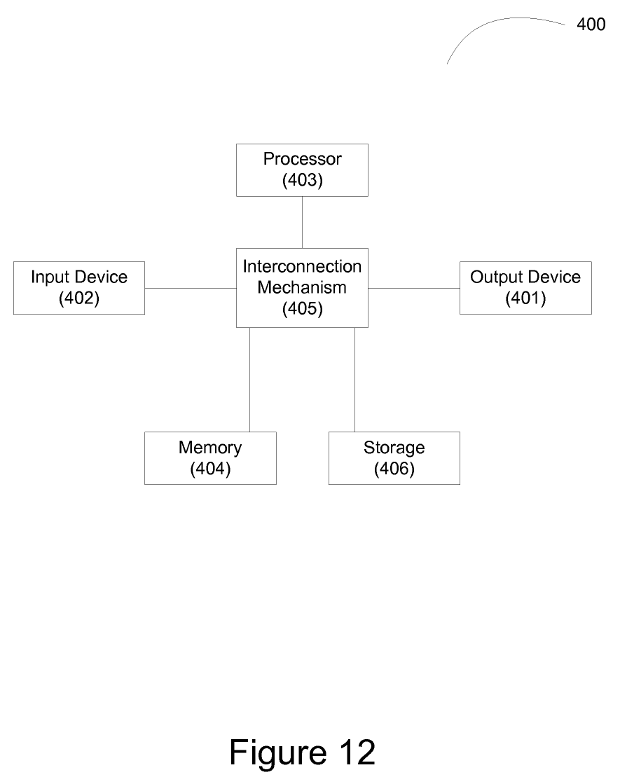

At least one aspect of the present invention relates to systems and methods for performing a data center hardware upgrade readiness assessment. The high level procedural flow of this method is shown in FIG. 1 and consists primarily of a service provider administering a questionnaire 204 to appropriate site personnel, using the information thus gathered to assess the data center 206, preparing results 208 of the assessment, and reporting the results 210. Components of this process may be implemented using a general-purpose computer system as discussed with regard to FIG. 12 below.

At block 202, process 200 begins. At block 204, a questionnaire is administered to personnel knowledgeable about the data center targeted for the readiness assessment. The questionnaire may be hardcopy or electronic. In general, this questionnaire will request basic data center information. In one embodiment, the specific information requested includes: the name of the entity that owns the data center; the name, address, telephone number, and email of site contact personnel; the data center name, address, intended use, access and security procedures, size, floor plan, floor loading and type, electrical schematic, projected life span, required availability, any accidental shutdown history due to power or cooling problems and expansion or relocation plans; any extant growth strategy for the power and cooling systems; the goals of the assessment; any known issues including power and cooling problems; and the manufacturer, model and amount of hardware that will be installed.

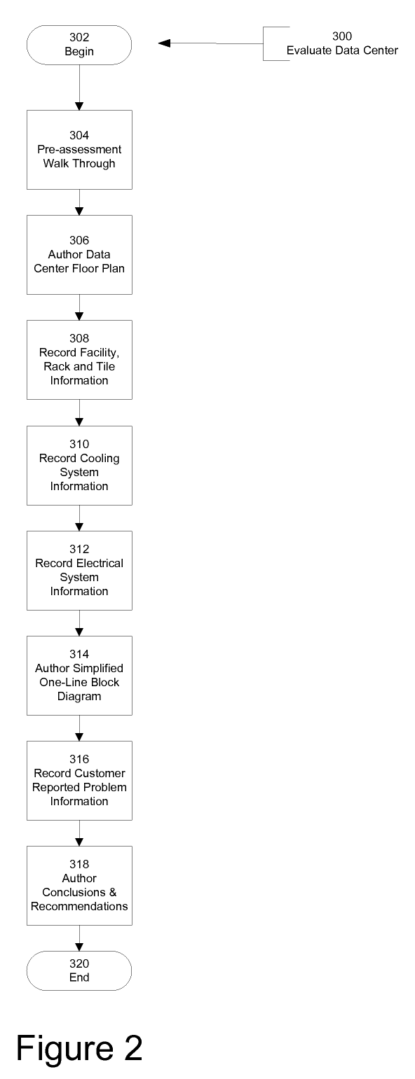

At block 206, the data center is assessed by the service provider. Typically, this assessment is conducted during an onsite visit. The assessment process for a particular embodiment is depicted in FIG. 2. At block 302, process 300 begins. At block 304, the service provider conducts a pre-assessment walk through of the data center. During a pre-assessment walk through, the service provider surveys the general condition of the data center paying particular attention to the cooling and ventilation systems, power distribution systems and facilities. The service provider may record characteristics of the data center using any recording device including simple pen and paper, a camera, voice recorder, portable computing device, infrared detector, power monitor, thermometer, balometer or other device.

At block 306, the service provider authors a data center floor plan. This floor plan may include data center equipment and air tiles (both floor and ceiling) and may be based on a pre-existing floor plan provided by data center personnel. A non-limiting list of data center equipment includes computer room air conditioning (CRAC) units, distribution panels, UPS's, racks, floor standing equipment, desks, tables and benches. In one embodiment, where a pre-existing floor plan is not available, the service provider authors the floor plan to scale using a 2×2 ft grid system. The equipment may be as precisely identified as possible, e.g. by serial number or other nomenclature used at the data center. Likewise, rows may be identified by name and the aisle temperature may be recorded along with other characteristics, such as whether it is a hot or cold, a front to back, or a mixed aisle. A pre-existing floor plan may simply be verified as having the pertinent information.

At block 308, the service provider records facility, rack and tile information. This information may cover all data center areas and rooms. Room information that may be recorded includes name, age, size, floor load rating, presence of exterior windows, any designated expansion space and evidence of physical damage. In one embodiment, information regarding a raised floor, if one is present, may include load rating, stability, plenum, percentage of penetrations sealed, whether the number of perforated tiles is excessive, any missing tiles, and the extent of cable congestion. In another embodiment, information pertaining to the suspended ceiling, if one is present, may include the type of plenum, the presence of missing tiles, the extent of cable congestion and the percentage of penetrations sealed.

The service provider collects physical and power related rack information. This may include the manufacturer, physical dimensions, location and porousness of the front and rear door, the presence of front or rear door fans, the presence of blanking panels, the quality of the cable management, power capacity in N configuration, power redundancy information, the category, density and percentage populated of the power supply, rack metering control and environmental features and the maximum inlet air temperature. The information regarding each tile may focus on airflow and temperature information regarding each tile. In an embodiment, the air flow is measured using a barometer and the temperature is obtained using an infrared thermometer.

At block 310, the service provider records cooling system bulk, nameplate and configuration information. This information includes name, manufacturer, model number, unit capacity, heat rejection method, orientation, air supply, air return flow and modes of operation. In an embodiment, the service provider takes optical photographs and voice annotates them. Cooling system bulk information describes the mechanical plant upstream from the CRAC units. This information includes unit name and capacity, the major unit components, and the identity and general description of the bulk cooling system redundancy. In an embodiment, the service provider takes optical photos of the equipment, including nameplates, and annotates them.

At block 312, the service provider records electrical system information. This information includes information about the upstream power supply to the data center, the static switch, uninterruptible power supply (UPS) distribution, power distribution units (PDU's) and circuit breaker distribution panels. The information gathered regarding the upstream power supply includes the manufacturer, number, fuel and capacity of an emergency generator, the manufacturer of the automatic transfer switch, the capacity of the main distribution switch and the UPS input. The information noted concerning the static switch may include name, capacity and source feed. The information collected concerning the UPS distribution includes name, capacity and redundancy data. The information recorded regarding the PDU's comprises name and capacity data. The information gathered pertaining to the circuit breakers includes name, capacity, number of poles and number of spare poles. The information recorded about the UPS may be capacity, capacity as installed, upgradeable capacity, input breaker and voltage, output breaker and voltage, loading characteristics, redundancy information, temperature and battery time.

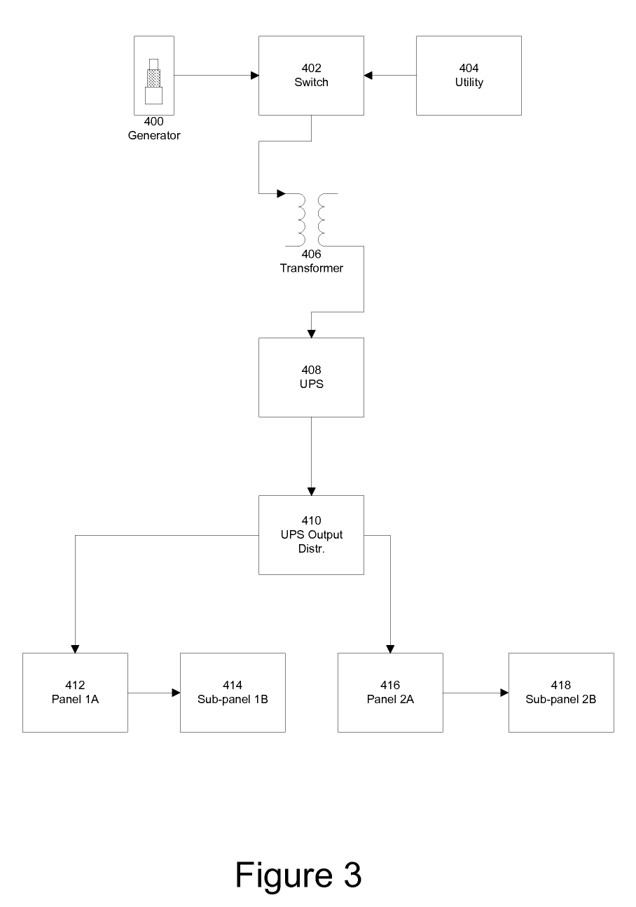

At block 314, the service provider uses the information gathered above to author a simplified one-line block diagram. As can be seen with reference to FIG. 3, this diagram depicts the electrical support infrastructure of the data center. The elements of the diagram may include auxiliary generator 400 and utility power feed 404 both of which are connected to static switch 402. Typically, static switch 402 will automatically switch from the utility power feed 404 to the auxiliary generator 400 in the event of a utility power failure. Static switch 402 connects with transformer 406, which, in turn feeds UPS 408. UPS 408 supplies power to UPS distributor 410 which feeds panels 1A and 2A. Panels 1A and 2A feed, respectively, sub-panels 1B and 2B.

Returning now to FIG. 2, at block 316 the service provider records and investigates any problems reported by data center personnel. This problem information may be reported through the assessment questionnaire or may be gathered from data center personnel as part of the assessing the data center. In one embodiment, the problem is recorded, the cause determined as part of assessing the data center and a solution is proposed.

At block 318, the service provider authors conclusions and recommendations. The conclusion and recommendations may follow a flow and content similar to block 304, the pre-assessment walk through. The conclusions and recommendations should generally address the overall quality of the data center installation and provide suggestions based on the goals of data center personnel for the data center. In an embodiment, the recommendations first state the problem to be solved, followed by the recommendation for solving it as well as a categorization into which the problem belongs, e.g. power, cooling, facility, rack, etc.

At block 320, process 300 ends.

Returning to FIG. 1, at block 208 the service provider prepares the results of the assessment. This may be accomplished by analyzing the data gathered in block 206 manually or in an automated fashion, e.g. by entering the data into a spreadsheet. The analysis may result in both tabular and graphical reports.

At block 210, results are generated. These results may be presented in various forms including a potential upgrade floor plan diagram, a projected data center load against available power and cooling diagram, a gross power capacity against utilized power capacity diagram, a gross cooling capacity against utilized cooling capacity diagram, a rack inlet temperature against cooling distribution floor plan diagram, a rack utilization floor plan diagram and a U space utilization diagram. The diagrams discussed above may be displayed on a computer system or provided as printed output from a computer system.

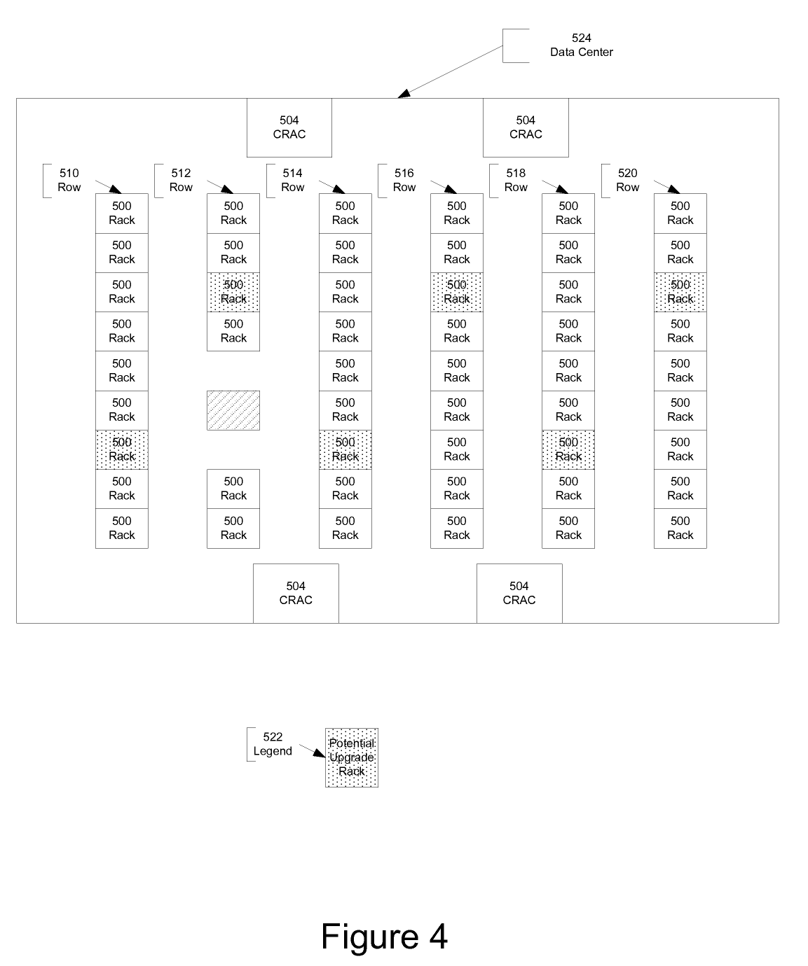

FIG. 4 shows a potential upgrade floor plan diagram. This diagram provides a graphical representation of the rack locations available to support new hardware. Rack indicators 500 are arranged into row indicators 510, 512, 514, 516, 518 and 520. Cooling unit indicators 504 are located within data center indicator 524 relative to the positions of the CRAC units in the data center. Legend 522 denotes how rack indicators 500 representing racks capable of support upgrade hardware are demarcated.

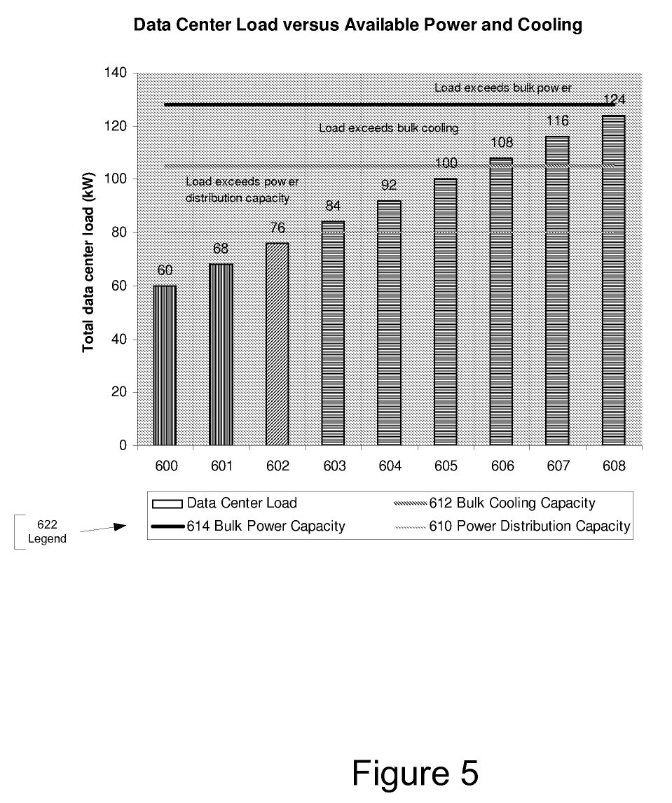

FIG. 5 depicts a projected data center load against available power and cooling diagram 650. This diagram provides a graphical representation of the capability of the current cooling and power systems to support differing amounts of upgrade hardware. Data center load indicators 600 through 608 represent total power consumption in kilowatts and are respectively shown in this example as 60, 68, 76, 84, 92, 100, 108, 116 and 124. This diagram depicts various projected increases in demand for power and cooling resources. As presented by legend 622, power and cooling capacity indicators 610, 612 and 614 respectively represent power distribution capacity, bulk cooling capacity and bulk power capacity. As projected data center load indicators 600 through 608 reach and exceed any of the capacity indicators, the display characteristics of the data center load indicators may change in a predefined manner, e.g. color or pattern changes.

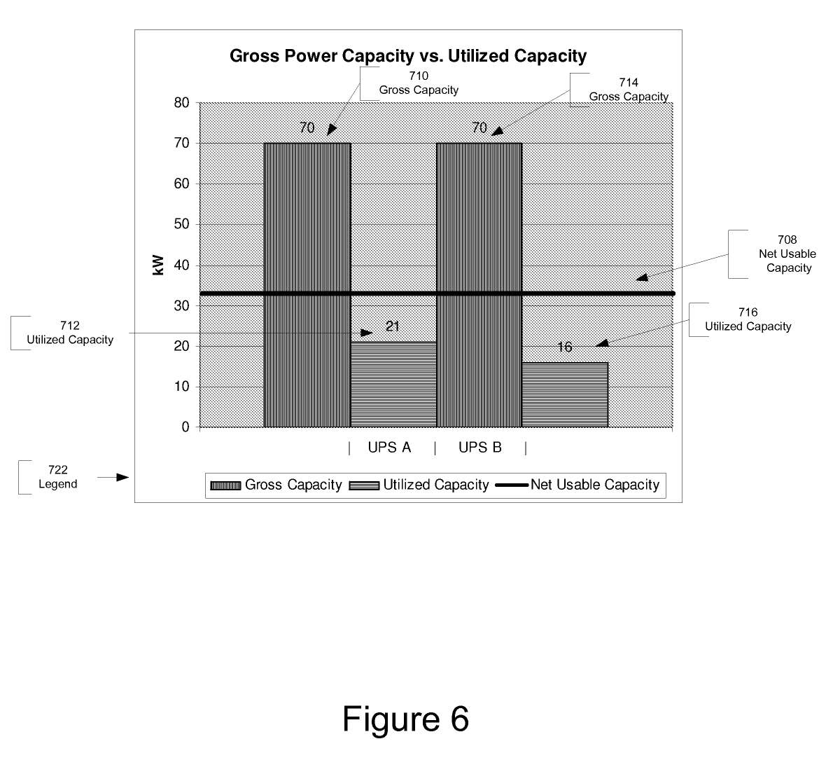

FIG. 6 provides a gross power capacity against utilized power capacity diagram. This diagram is a graphical representation of the gross and useable power system capacity relative to the current data center load. Gross capacity indicators 710 and 714 represent the gross power capacity of a data center UPS's A and B, respectively, which as indicated in the example are equal to 70 kilowatts. Utilized capacity indicators 712 and 716 represent the data center power load drawn from UPS's A and B, respectively, which are shown in the example as 21 and 16 kilowatts. As presented by legend 722, net usable capacity indicator 708 represents useable capacity of the data center as a whole, which is shown as 32. As data center power load drawn reaches and exceeds certain percentages of the net usable capacity of the data center, the characteristics of the utilized capacity indicators may change in a predefined manner, e.g. color or pattern changes. In one embodiment, the utilized capacity indicators 712 and 716 are shaded green if the utilized capacity is less than 70% of usable capacity, yellow if the utilized capacity percentage is within the range of 70% to 79% and red if the utilized capacity percentage is 80% or greater.

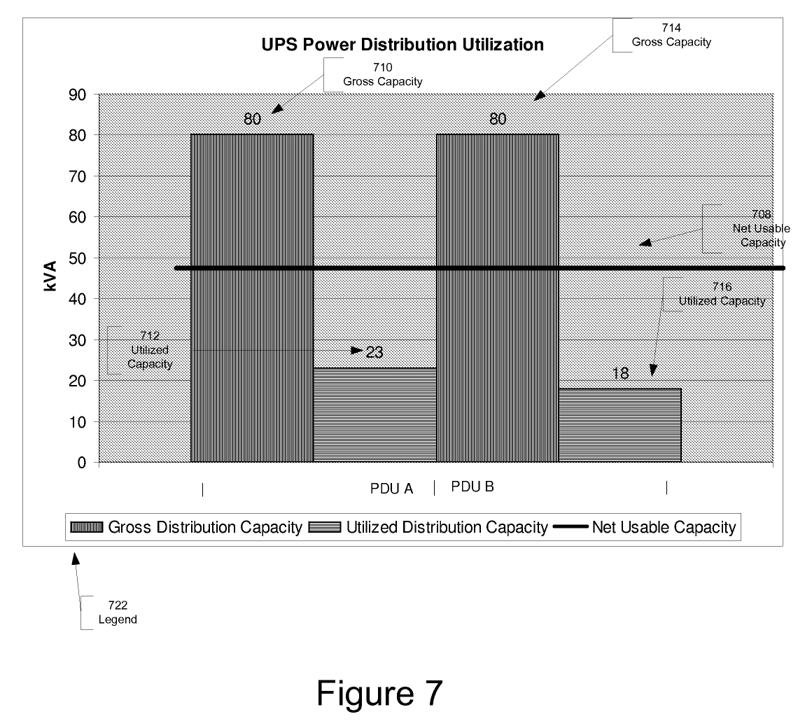

FIG. 7 provides a gross power distribution capacity against utilized power distribution capacity diagram. This diagram is a graphical representation of the gross and useable power distribution system capacity relative to the current data center load. Gross distribution capacity indicators 710 and 714 represent the gross power distribution capacity of a data center PDU's A and B, respectively, which as indicated in the example are equal to 80 kilovoltamps. Utilized distribution capacity indicators 712 and 716 represent the data center power load drawn from PDU's A and B, respectively, which are shown in the example as 23 and 18 kilovoltamps. As presented by legend 722, net usable distribution capacity indicator 708 represents useable distribution capacity of the data center as a whole, which is shown as 48. As data center power load drawn reaches and exceeds certain percentages of the net usable distribution capacity of the data center, the characteristics of the utilized distribution capacity indicators may change in a predefined manner, e.g. color or pattern changes. In one embodiment, where the power distribution system has N or N+1 redundancy, the utilized distribution capacity indicators 712 and 716 are shaded green if the utilized capacity is less than 70% of usable capacity, yellow if the utilized capacity percentage is within the range of 70% to 79% and red if the utilized capacity percentage is 80% or greater. In another embodiment, where the power distribution system has 2N redundancy, the utilized distribution capacity indicators 712 and 716 are shaded green if the utilized capacity is less than 35% of usable capacity, yellow if the utilized capacity percentage is within the range of 35% to 39% and red if the utilized capacity percentage is 40% or greater.

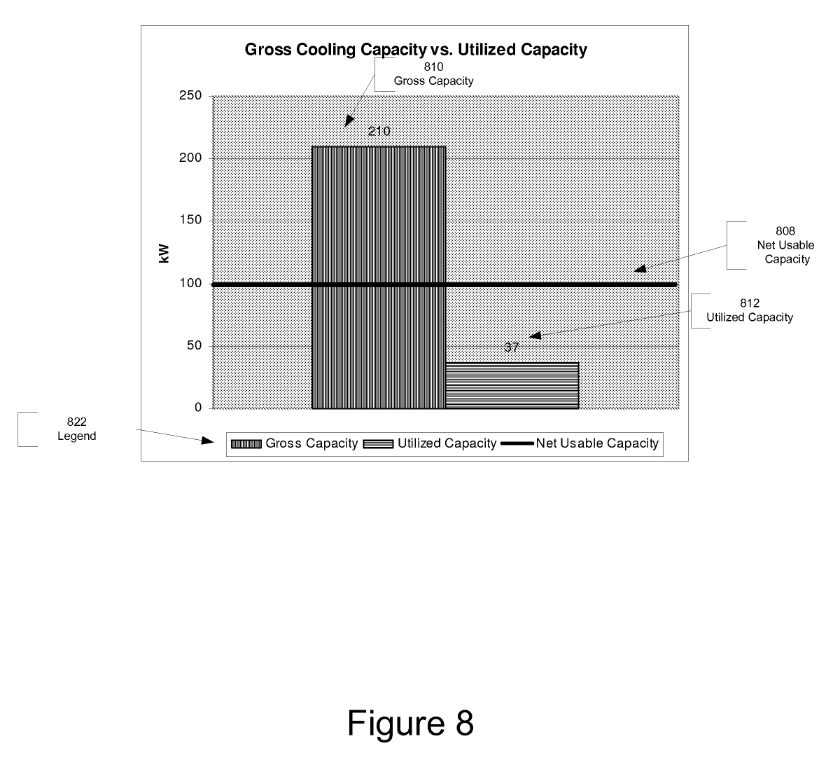

FIG. 8 illustrates a gross cooling capacity against utilized cooling capacity diagram. This diagram is a graphical representation of the cooling system capacity relative to the current data center load. Gross capacity indicator 810 represents the gross cooling capacity of a data center, which here is 210 kilowatts. Utilized capacity indicators 812 represents the data center cooling load drawn, which in this example is 37 kilowatts. As presented by legend 822, net usable capacity indicator 808 represents useable capacity of the data center as a whole, which is depicted in this example as 100. As data center cooling load drawn reaches and exceeds certain percentages of the net usable capacity of the data center, the characteristics of the utilized capacity indicator 812 may change in a predefined manner, e.g. color or pattern changes. In an embodiment, the utilized capacity indicator 812 is shaded green if utilization allows for N+1 CRAC redundancy, yellow if utilization is greater than N+1 CRAC capacity and red if utilization is at or above N CRAC capacity.

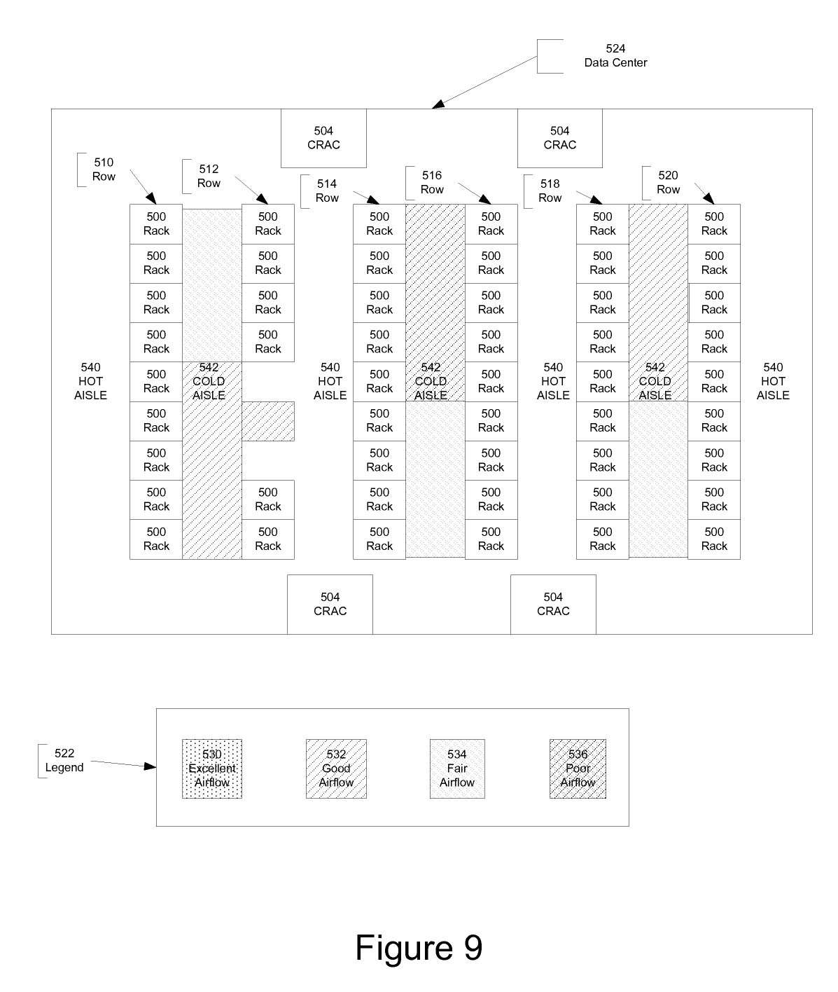

FIG. 9 shows a rack inlet temperature against cooling distribution floor plan diagram. This diagram is a graphical representation of rack inlet temperatures relative to cooling distribution. Rack indicators 500 are arranged into row indicators 510, 512, 514, 516, 518 and 520. Cooling unit indicators 504 are located within data center indicator 524 relative to the positions of the CRAC units in the data center. Hot aisle indicators 540 mark which aisles within a data center are designated as hot aisles and, conversely, cold aisle indicators 542 indicate which aisles are designated as cold aisles. Legend 522 defines the quality of airflow within a represented area of the data center denoted by airflow indicators where the patterns in 530, 532, 534 and 536 are displayed. In an embodiment, airflow indicator 530 denotes more than 600 cfm, 532 denotes 400 to 600 cfm, 534 denotes 200 to 400 cfm and 536 denotes less than 200 cfm. In another embodiment, where the data center represented has hard floors, airflow indictors are omitted and hot aisle indicators 540 and cold aisles indicators 542 display recorded temperatures.

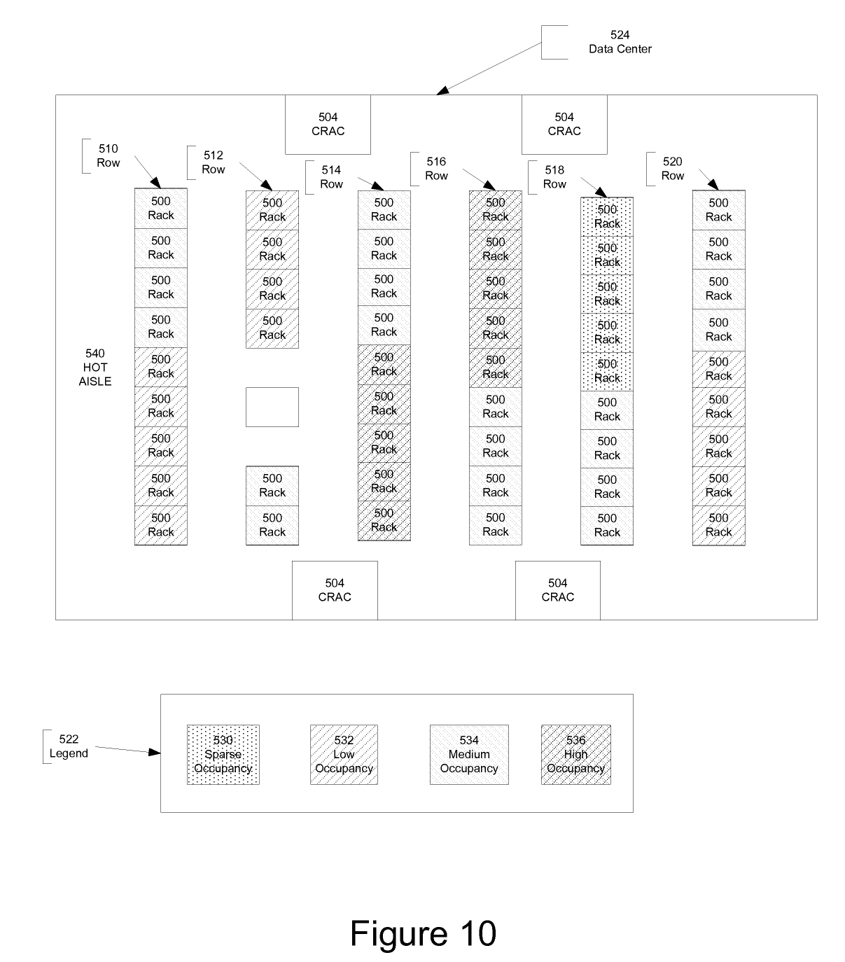

FIG. 10 depicts a rack utilization floor plan diagram. This diagram is a graphical representation of the occupancy rates of data center racks. Rack indicators 500 are arranged into row indicators 510, 512, 514, 516, 518 and 520. Cooling unit indicators 504 are located within data center indicator 524 relative to the positions of the CRAC units in the data center. Legend 522 defines the occupancy rates within a represented rack of the data center denoted by occupancy rate indicators where the patterns in 530, 532, 534 and 536 are displayed. In an embodiment, rack occupancy indicator 536 denotes 76% to 100% occupancy, 534 denotes 51% to 75% occupancy, 533 denotes 26% to 50% occupancy and 530 denotes less than 25% occupancy.

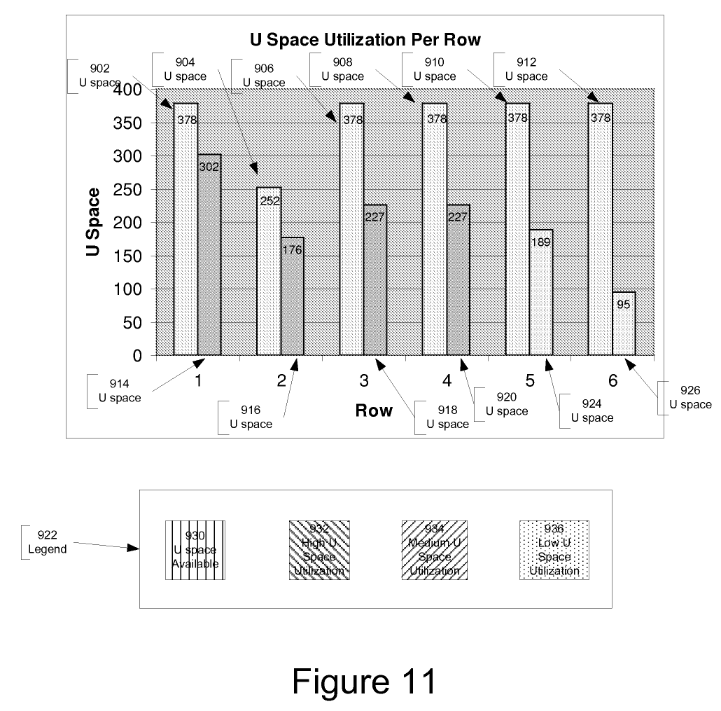

FIG. 11 illustrates a U space utilization diagram. This diagram is a graphical representation of the U space utilized by data center row. Data center row available U space indicators 902, 904, 906, 908, 910 and 912 respectively represent the U space available per data center rows 1, 2, 3, 4, 5 and 6, and are shown in this example as 378, 252, 378, 378, 378 and 378, respectively. Utilized U space indicators 914, 916, 918, 920, 924 and 926 respectively represent U space utilized per data center rows 1, 2, 3, 4, 5 and 6, and are depicted in this example as 302, 176, 227, 227, 189 and 95, respectively. Legend 922 defines the pattern associated with available U space indicator 930. Similarly, legend 922 defines the U space utilization rates within a represented rack of the data center denoted by utilized U space indicators where the patterns in 932, 934 and 936 are displayed. It should be appreciated that legend 922 may use various colors instead of or addition to patterns to define represented space utilization rates. In an embodiment, U space utilization indicators are shaded red when representing U space utilization of 76% to 100%, shaded yellow when representing U space utilization of 51% to 75%, shaded green when representing U space utilization of 26% to 50%, and not shaded when representing U space utilization of less than 25%.

A process for performing a data center hardware upgrade readiness assessment 200 according to one embodiment of the invention may be implemented on one or more general-purpose computer systems. For example, various aspects of the invention may be implemented as specialized software executing in a general-purpose computer system 400 such as that shown in FIG. 12. Computer system 400 may include one or more output devices 401, one or more input devices 402, a processor 403 connected to one or more memory devices 404 through an interconnection mechanism 405 and one or more storage devices 406 connected to interconnection mechanism 405. Output devices 401 typically render information for external presentation and examples include a monitor and a printer. In an embodiment of the invention described above, output devices 401 may be used to provide representations of attributes of data centers, such as shown in FIGS. 3 through 11 Input devices 402 typically accept information from external sources and examples include a keyboard and a mouse. Processor 403 typically performs a series of instructions resulting in data manipulation. Processor 403 is typically a commercially available processor such as an Intel Pentium, Motorola PowerPC, SGI MIPS, Sun UltraSPARC, or Hewlett-Packard PA-RISC processor, but may be any type of processor. Memory devices 404, such as a disk drive, memory, or other device for storing data is typically used for storing programs and data during operation of the computer system 400. Devices in computer system 400 may be coupled by at least one interconnection mechanism 405, which may include, for example, one or more communication elements (e.g., busses) that communicate data within system 400.

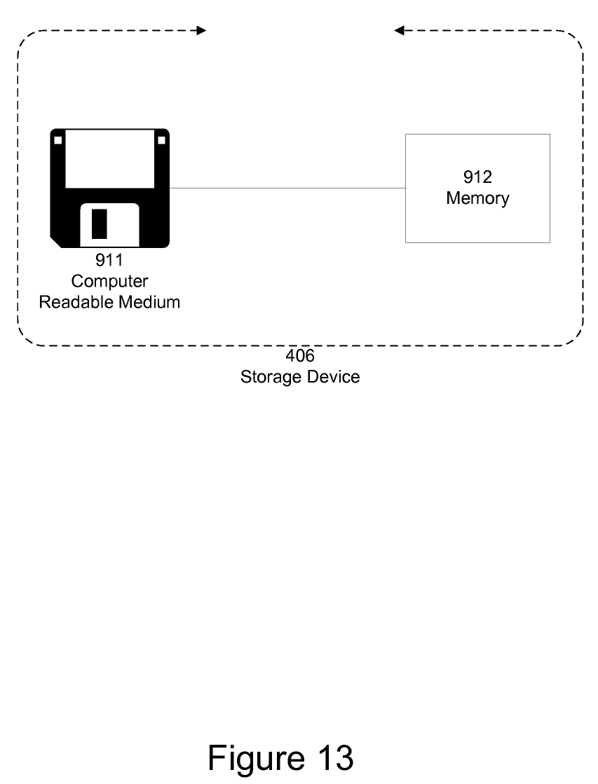

The storage device 406, shown in greater detail in FIG. 13, typically includes a computer readable and writeable nonvolatile recording medium 911 in which signals are stored that define a program to be executed by the processor or information stored on or in the medium 911 to be processed by the program. The medium may, for example, be a disk or flash memory. Typically, in operation, the processor causes data to be read from the nonvolatile recording medium 911 into another memory 912 that allows for faster access to the information by the processor than does the medium 911. This memory 912 is typically a volatile, random access memory such as a dynamic random access memory (DRAM) or static memory (SRAM). It may be located in storage device 406, as shown, or in memory device 404. The processor 403 generally manipulates the data within the memory 404, 912 and then copies the data to the medium 911 after processing is completed. A variety of mechanisms are known for managing data movement between the medium 911 and the memory 404, 912, and the invention is not limited thereto. The invention is not limited to a particular memory device 404 or storage device 406.

Computer system 400 may be implemented using specially programmed, special purpose hardware, or may be a general-purpose computer system that is programmable using a high-level computer programming language. Computer system 400 usually executes an operating system which may be, for example, the Windows 95, Windows 98, Windows NT, Windows 2000 (Windows ME) or Windows XP operating systems available from the Microsoft Corporation, MAC OS System X available from Apple Computer, the Solaris Operating System available from Sun Microsystems, or UNIX operating systems available from various sources (e.g., Linux). Many other operating systems may be used, and the invention is not limited to any particular implementation. For example, in an embodiment, a U space utilization diagram may be generated using a general-purpose computer system with a Sun UltraSPARC processor running the Solaris operating system.

Although computer system 400 is shown by way of example as one type of computer system upon which various aspects of the invention may be practiced, it should be appreciated that the invention is not limited to being implemented on the computer system as shown in FIG. 12. Various aspects of the invention may be practiced on one or more computers having a different architecture or components than that shown in FIG. 12. To illustrate, one embodiment of the present invention may acquire data center information using several general-purpose computer systems running MAC OS System X with Motorola PowerPC processors and several specialized computer systems running proprietary hardware and operating systems.

As depicted in FIG. 13, one or more portions of the system may be distributed to one or more computers (e.g., systems 109-111) coupled to communications network 108. These computer systems 109-111 may also be general-purpose computer systems. For example, various aspects of the invention may be distributed as components among one or more computer systems configured to provide a service (e.g., servers) to one or more client computers, or to perform an overall task as part of a distributed system. These components may be executable, intermediate (e.g., IL) or interpreted (e.g., Java) code which communicate over a communication network (e.g., the Internet) using a communication protocol (e.g., TCP/IP). To illustrate, one embodiment may acquire data center information though a browser interpreting HTML forms and may interface with a spreadsheet application using a data translation service running on a separate server.

Various embodiments of the present invention may be programmed using an object-oriented programming language, such as SmallTalk, Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof. For example, a power system data entry screen may be implemented using Visual Basic while the application designed to display a rack utilization floor plan diagram may be written in C++.

It should be appreciated that a general-purpose computer system in accord with the present invention may perform functions outside the scope of the invention. For instance, aspects of the system may be implemented using an existing commercial product, such as, for example, Database Management Systems such as SQL Server available from Microsoft of Seattle Wash., Oracle Database from Oracle of Redwood Shores, Calif.; Middleware products such as WebSphere middleware from IBM of Armonk, N.Y.; and User Applications such as Microsoft Word and Microsoft Excel from Microsoft of Seattle Wash. If SQL Server is installed on a general-purpose computer system to implement an embodiment of the present invention, the same general-purpose computer system may be able to support databases for sundry applications.

Based on the foregoing disclosure, it should be apparent to one of ordinary skill in the art that the invention is not limited to a particular computer system platform, processor, operating system, network, or communication protocol. Also, it should be apparent that the present invention is not limited to a specific architecture or programming language.

Having now described some illustrative embodiments of the invention, it should be apparent to those skilled in the art that the foregoing is merely illustrative and not limiting, having been presented by way of example only. While the bulk of this disclosure is focused on data center embodiments, aspects of the present invention may be applied to other types of information technology networks, for instance LAN's and WAN's. Similarly, aspects of the present invention may be used to achieve other objectives including power conservation. Numerous modifications and other illustrative embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments.

What is claimed is:

1. A method for evaluating a capability of a data center to support dense resource demand hardware, the method comprising:
gathering information related to attributes of the data center;
processing the information to determine the capability of the data center to support dense resource demand hardware; and
displaying a representation of the data center based on the processed information indicating the capability of the data center to support dense resource demand hardware.

2. The method according to claim 1, wherein gathering information related to attributes of the data center comprises gathering, by presenting a sequence of questions, information related to the attributes of the data center.

3. The method according to claim 1, wherein gathering information related to attributes of the data center comprises any of the group including:
conducting a pre-assessment walk through;
recording facility, rack and tile information;
recording cooling system information;
recording electrical system information; and
recording customer reported problem information.

4. The method according to claim 1, wherein processing the information to determine the capability of the data center to support dense resource demand hardware comprises processing the information to determine the capability of the data center to support blade server hardware.

5. The method according to claim 1, wherein displaying the representation of the data center comprises displaying a plurality of rack indicators, each rack indicator representing a rack disposed within the data center, and wherein the method further includes identifying at least one of the plurality of rack indicators representing a rack targeted for additional hardware.

6. The method according to claim 1, wherein displaying the representation of the data center comprises:
displaying at least one power supply load indicator representing power supply load of a power supply of the data center;
displaying at least one gross power supply capacity indicator representing gross power supply capacity of a power supply of the data center; and
displaying at least one net power supply capacity indicator representing net power supply capacity of a power supply of the data center.

7. The method according to claim 1, wherein displaying the representation of the data center comprises:
displaying at least one power distribution load indicator representing power distribution load of the data center;
displaying at least one gross power distribution capacity indicator representing gross power distribution capacity of the data center; and
displaying at least one net power distribution capacity indicator representing net power distribution capacity of the data center.

8. The method according to claim 1, wherein displaying the representation of the data center comprises:
displaying at least one cooling load indicator representing the cooling load of the data center;
displaying at least one gross cooling capacity indicator representing the gross cooling capacity of the data center; and
displaying at least one net cooling capacity indicator representing the net cooling capacity of the data center.

9. The method according to claim 1, wherein displaying the representation of the data center comprises:
displaying at least one rack indicator representing a rack having a rack inlet temperature and disposed within the data center, the at least one rack indicator indicating the rack inlet temperature;
displaying at least one hot aisle indicator representing a hot aisle disposed within the data center;
displaying at least one cold aisle indicator representing a cold aisle disposed with the data center; and
displaying at least one air flow indicator representing a flow of air within an indicated volume of the data center.

10. The method according to claim 1, wherein displaying the representation of the data center comprises:
displaying at least one rack indicator representing a rack having a rack inlet temperature and disposed within the data center, the at least one rack indicator indicating the rack inlet temperature;
displaying at least one hot aisle indicator representing a hot aisle having a hot aisle temperature and disposed within the data center, the at least one hot aisle indicator indicating hot aisle temperature; and
displaying at least one cold aisle indicator representing a cold aisle having a cold aisle temperature and disposed with the data center, the at least one cold aisle indicator indicating cold aisle temperature.

11. The method according to claim 1, wherein displaying the representation of the data center comprises displaying at least one rack indicator representing a rack having a rack occupancy percentage and disposed within the data center, the at least one rack indicator indicating the rack occupancy percentage.

12. The method according to claim 1, wherein displaying the representation of the data center comprises:
displaying at least one rack space capacity indicator representing the rack space capacity of an indicated volume within the data center; and
displaying at least one rack space utilization indicator representing the rack space utilization of the indicated volume.

13. The method according to claim 1, wherein displaying the representation of the data center comprises:
displaying at least one power and cooling indicator representing power and cooling load of the data center;
displaying at least one bulk power capacity indicator representing bulk power capacity of the data center;
displaying at least one bulk cooling capacity indicator representing bulk cooling capacity of the data center; and
displaying at least one power distribution capacity indicator representing power distribution capacity of the data center.

14. The method according to claim 13, wherein displaying the representation of the data center further comprises displaying at least one projected power and cooling indicator representing a projected power and cooling load for the data center.

15. A computer-readable medium having computer-readable signals stored thereon that define instructions that, as a result of being executed by a processor, instruct the processor to perform a method for displaying a capability of a data center to support dense resource demand hardware comprising:
gathering information related to attributes of the data center;
processing the information to determine the capability of the data center to support dense resource demand hardware; and
displaying a representation of the data center based on the processed information indicating the capability of the data center to support dense resource demand hardware.

16. The computer readable medium according to claim 15 wherein gathering information related to attributes of the data center comprises gathering, by presenting a sequence of questions, information related to the attributes of the data center.

17. The computer readable medium according to claim 15 wherein displaying the representation of the data center comprises:
displaying at least one power and cooling indicator representing the power and cooling load of the data center;
displaying at least one bulk power capacity indicator representing the bulk power capacity of the data center;
displaying at least one bulk cooling capacity indicator representing the bulk cooling capacity of the data center; and
displaying at least one power distribution capacity indicator representing the power distribution capacity of the data center.

18. The computer readable medium according to claim 17, wherein displaying the representation of the data center further comprises displaying at least one projected power and cooling indicator representing a projected power and cooling load for the data center.

19. A system for displaying a capability of a data center to support dense resource demand hardware, the system comprising:
an input configured to gather information related to attributes of the data center;
an output configured to display a representation indicating the capability of the data center to support dense resource demand hardware;
a processor, coupled to the input and the output, and configured to determine the capability of the data center to support dense resource demand hardware and to instruct the output to display the representation; and
a storage device coupled to the processor.

20. The system according to claim 19 wherein the input is configured to gather the information by displaying a sequence of questions.

21. The system according to claim 19 wherein the input is configured to gather the identity of at least one rack targeted for additional hardware and the representation comprises at least one rack indicator representing the at least one rack.

22. The system according to claim 19 wherein the representation comprises:
at least one power and cooling indicator representing power and cooling load of the data center;
at least one bulk power capacity indicator representing bulk power capacity of the data center;
at least one bulk cooling capacity indicator representing bulk cooling capacity of the data center; and
at least one power distribution capacity indicator representing power distribution capacity of the data center.

23. The system according to claim 19 wherein the representation comprises at least one projected power and cooling indicator representing a projected power and cooling load for the data center.

24. The system according to claim 19 wherein the representation comprises:
at least one power supply load indicator representing power supply load of a power supply of the data center;
at least one gross power supply capacity indicator representing gross power supply capacity of a power supply of the data center; and
at least one net power supply capacity indicator representing net power supply capacity of a power supply of the data center.

25. The system according to claim 19 wherein the representation comprises:
at least one power distribution load indicator representing power distribution load of the data center;
at least one gross power distribution capacity indicator representing gross power distribution capacity of the data center; and
at least one net power distribution capacity indicator representing net power distribution capacity of the data center.
